(19) United States
(12) Patent Application Publication
(10) Pub. No.: US 2015/0019340 A1
(43) Pub. Date: Jan. 15, 2015

(54) SYSTEMS AND METHODS FOR PROVIDING INFORMATION TO AN AUDIENCE IN A DEFINED SPACE

(71) Applicant: Visio Media, Inc., Edmonton (CA)

(72) Inventors: Fouad EL-MASRI, Edmonton (CA); Boaz LAU, Edmonton (CA); Bruce JOHNSON, Sherwood Park (CA)

(21) Appl. No.: 14/327,257

(22) Filed: Jul. 9, 2014

Related U.S. Application Data
(60) Provisional application No. 61/844,510, filed on Jul. 10, 2013.

(51) Int. Cl. G06Q 30/02

(52) U.S. Cl. CPC G06Q 30/0265; G06Q 30/0269
USPC 705/14.62

(57) ABSTRACT

Systems and methods are provided providing information in a defined space. An exemplary method may include receiving data related to one or more individuals in the defined space. The received data may be used for identifying the one or more individuals based on the received data and one or more brands associated with the one or more individuals based on the received data. The method may further include determining the information to display based on the identification of the one or more individuals and the identification of the one or more brands associated with the one or more individuals.

### CROSS-REFERENCE TO RELATED APPLICATIONS

This Application claims the benefit of priority from Provisional Application No. 61/844,510, entitled “Method and Apparatuses for Elevator Information and Advertising Displays,” filed Jul. 10, 2013, which is incorporated herein by reference in its entirety.

### TECHNICAL FIELD

Various embodiments of the present disclosure relate generally to displaying advertising content in defined spaces such as, e.g., elevators, airport terminals, waiting rooms, sports stadiums, libraries, coffee shops, etc. More specifically, particular embodiments of the present disclosure relate to systems and methods for providing digital information and advertising in an elevator using the internet to update a display in the elevator based on elevator passenger data that is identified and analyzed.

### BACKGROUND

Providing advertising content on a display in an elevator is an important advertising mechanism that is used currently. Most of these elevator displays provide generic advertisement along with other information such as weather and news. Conventionally, a computer processing unit (CPU), sitting on top of an elevator shaft, provides content to display to the display screen in the elevator cab. The CPU is connected to the display screen via local area network (LAN) cables. This can be a costly and ineffective installation where a CPU sits on top of the elevator shaft and is wired to a display screen (disposed within the elevator cab).

Typically, passenger data regarding passengers in an elevator cab may also be gathered. For example, sensors may be used to track how many people enter into an elevator cab. In some systems, an analytics count may be conducted through an elevator occupancy detector, for example, using video sensors with gray scale analyzers, weight detection, or reflector laser detection to count how many people enter and exit the elevator cab. However, these systems are crude and inefficient and do not provide sufficient information to customize the advertising to the passengers.

### SUMMARY OF THE DISCLOSURE

Embodiments disclose systems and methods for providing information to an audience in a defined spaced, such as, e.g., an elevator cab.

According to some embodiments, computer-implemented methods are disclosed for providing information in a defined space. In an exemplary method, the method includes receiving data related to one or more individuals in the defined space, identifying the one or more individuals based on the received data, and identifying one or more brands associated with the one or more individuals based on the received data. The method further includes determining the information to display based on the identification of the one or more individuals and the identification of the one or more brands associated with the one or more individuals.

In embodiments, the method may include one or more of: providing information includes graphically displaying images on a screen; interacting with the graphically displayed images on the screen using one or more of social media platforms, motions, voice, texting, touching, NFC, and Bluetooth; wherein receiving the data related to one or more individuals in the defined space comprises receiving data related to the one or more individual that is captured by one or more sensors in the defined space; wherein the one or more sensors include a camera, a microphone, and a motion detector; wherein identifying the one or more individuals based on the received data comprises identifying the one or more individuals by determining one or more of biometric information, demographic information, facial expression, mac address, and WiFi networks saved in a device associated with a respective individual; identifying the one or more brands associated with the one or more individuals based on the received data comprises determining respective brands of products worn, carried by, or discussed by the one or more individuals using data captured by the one or more sensors; determining the information to provide is based additionally on one or more of weather, time of day, and geographical location; the defined space is an elevator and the information is electronic advertisement; a display device in the elevator is connected to a client on-board server that is connected to a client server disposed in an elevator control room using an electrical power conduit; a display device in the elevator is connected to a server providing the information using an LTE connection; and providing the information to a display device in the defined space for displaying.

According to some embodiments, systems are disclosed for providing information in a defined space. One system includes a memory having processor-readable instructions stored therein and a processor configured to access the memory and execute the processor-readable instructions, which when executed by the processor configures the processor to perform a method. In an exemplary method, the method includes receiving data related to one or more individuals in the defined space, identifying the one or more individuals based on the received data, and identifying one or more brands associated with the one or more individuals based on the received data. The method further includes determining the information to display based on the identification of the one or more individuals and the identification of the one or more brands associated with the one or more individuals.

According to some embodiments, a non-transitory computer readable medium is disclosed as storing instructions that, when executed by a computer, cause the computer to perform a method, the method includes receiving data related to one or more individuals in the defined space, identifying the one or more individuals based on the received data, and identifying one or more brands associated with the one or more individuals based on the received data. The method further includes determining the information to display based on the identification of the one or more individuals and the identification of the one or more brands associated with the one or more individuals.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram of a network environment for displaying advertising content in an elevator, according to an embodiment of the present disclosure.

FIG. 2 is a block diagram of an information disclosing system, according to an embodiment of the present disclosure.

FIG. 3 is another block diagram of an information disclosing system, according to an embodiment of the present disclosure.

FIG. 4 is a flow diagram of an exemplary method for displaying advertising content in elevators, according to an embodiment of the present disclosure.

FIG. 5 is a block diagram of an exemplary computer system in which embodiments of the present disclosure may be implemented.

### DESCRIPTION OF THE EMBODIMENTS

While the present disclosure is described herein with reference to illustrative embodiments for particular applications, it should be understood that embodiments of the present disclosure are not limited thereto. Other embodiments are possible, and modifications can be made to the described embodiments within the spirit and scope of the teachings herein, as they may be applied to the above-noted field of the present disclosure or to any additional fields in which such embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In view of the challenges associated with the conventional techniques outlined above, systems and methods are disclosed herein for providing information to an audience in a defined space, such as, e.g., elevators, airport terminals, waiting rooms, sports stadiums, libraries, coffee shops, train compartments, taxi cabs, and commercial airline seat-back entertainment consoles, etc..

Reference will now be made in detail to the exemplary embodiments of the disclosure, examples of which are illustrated in the accompanying drawings. Wherever possible, the same reference numbers will be used throughout the drawings to refer to the same or like parts.

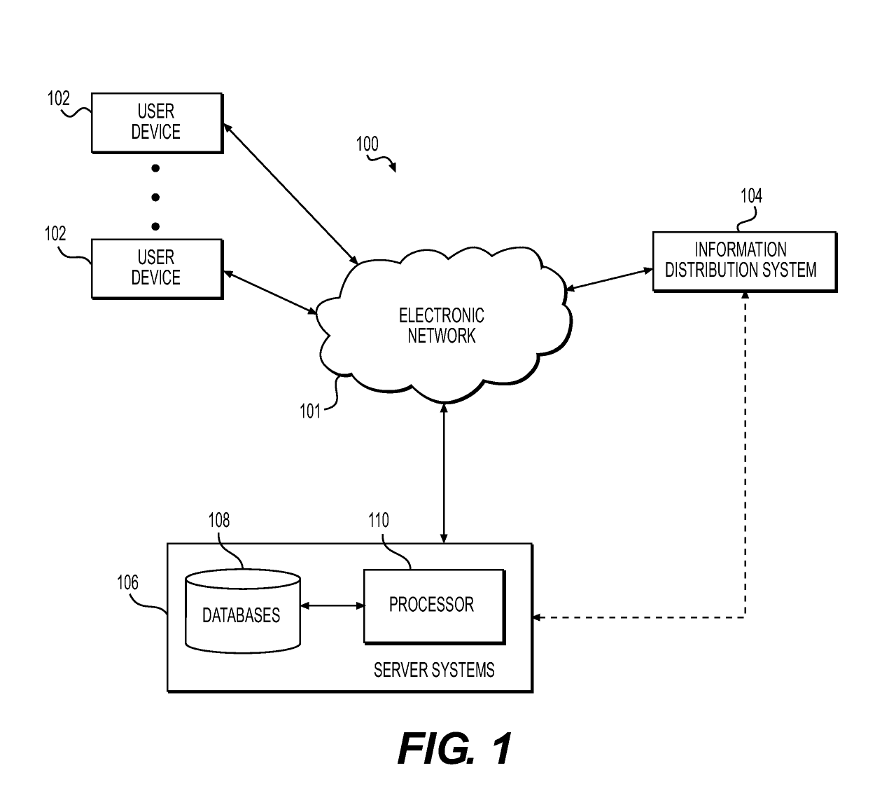

FIG. 1 is a schematic diagram of an exemplary network environment 100 in which various systems may display advertising content in defined space, such as, e.g., an elevator cab, according to an embodiment of the present disclosure. As shown in FIG. 1, the environment 100 may include a plurality of user or client devices 102 that are communicatively coupled to each other as well as one or more server systems 106 via an electronic network 101. Electronic network 101 may include one or a combination of wired and/or wireless electronic networks. Network 101 may also include a local area network, a medium area network, or a wide area network, such as the Internet Electronic network 101 may be a collection of data terminals connected through a local ISP based on GSM/EDGE and UMTS/HSPA network (LTE+ backward compatibility), or a distribution network which uses multiple modem demodulating ISP feeds. In some embodiments, the distribution network may be, for example, a cellular router, such as a Sierra Mobile Hotspot Bell Mobility™. Those of ordinary skill in the art will recognize that the distribution network may be located at any suitable location, including within an elevator cab, elevator shaft, or any other disclosed location. In an embodiment, the distribution network may be disposed in an elevator control room.

Furthermore, environment 100 may include information distribution system 104, which may include one or more displays for the elevators. In embodiments, information distribution system 104 may be physically located at the defined space. For example, if the information is being provided to an elevator in a building, all the elements of the information distribution system 104 may be located at or in the vicinity of the building. Information distribution system 104 may allow for relaying of information from server system 106 to an audience in a defined space, such as displaying advertising content on an elevator display for passengers in an elevator cab. The information that may be relayed may include data comprising rich site summary feeds, target advertisements, and building notices created and implemented by users using user or client devices 102. Accordingly, in an exemplary embodiments, information that is being displayed on a tablet in information distribution system 104 may be stored and received from the cloud or may be stored locally as part of network environment 100. For example, the tablet may display a website utilizing a URL. In such a scenario, displayed information may be updated based on information hosted on the URL location. Alternatively, packets may be provided directly to the tablet for updating the display locally.

In one embodiment, each of user or client devices 102 may be any type of computing device configured to send and receive different types of content and data to and from various computing devices via network 101. Examples of such a computing device include, but are not limited to, a desktop computer or workstation, a laptop computer, a mobile handset, a personal digital assistant (PDA), a cellular telephone, a network appliance, a camera, a smart phone, an enhanced general packet radio service (EGPRS) mobile phone, a media player, a navigation device, a game console, a set-top box, a biometric sensing device with communication capabilities, or any combination of these or other types of computing devices having at least one processor, a local memory, a display (e.g., a monitor or touchscreen display), one or more user input devices, and a network communication interface. The user input device(s) may include any type or combination of input/output devices, such as a keyboard, touchpad, mouse, touchscreen, camera, and/or microphone.

In one embodiment, each of the user or client devices 102 may be configured to execute a web browser, mobile browser, or additional software applications that allows for input from various individuals including internet providers of online content.

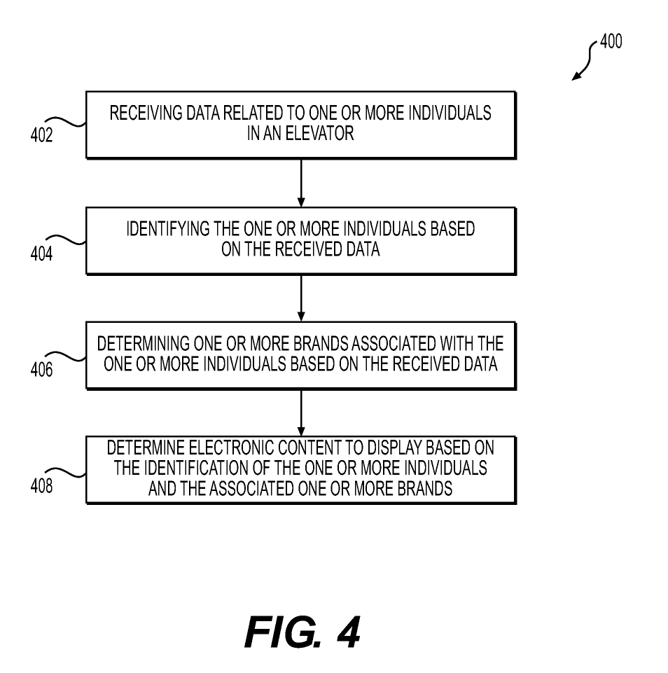

Server system 106 in turn may be configured to receive data related to advertising content and data related to the presence of individuals in an elevator cab. It should be noted that while a singular server system 106 is described, method 400, described below with respect to FIG. 4, may be implemented using a plurality of server systems working in combination, a single server device, or a single system.

Also, as shown in FIG. 1, server system 106 may include one or more databases 108. In an embodiment, databases 108 may be any type of data store or recording medium that may be used to store any type of data. For example, databases 108 may store data received by or processed by server system 106 including information related to individuals in an elevator, a biometrics library, a library related to various brands, and advertising content, etc.

Additionally, as shown in the example of FIG. 1, server system 106 may include processor 110. In an embodiment, processor 110 may be configured to execute a process for displaying electronic content in a defined space, such as, the elevator cab of the discussed embodiment. In one example, the displaying process may continue to constantly monitor traffic in an elevator cab, analyze data related to individuals in the elevator, and provide unique advertising contents based on the analyzed data. Data related to individuals in a defined space, such as the elevator, may be used to determine various analytics regarding the individuals including gender, approximate age, approximate height and weight, facial expressions, brand recognition, and average attention span. These analytics along with external factors such as weather or a particular time schedule may be used to providing targeted information, such as, e.g., target advertising content. In embodiments, in addition to using these analytics for providing customized content (such as advertisement), the analytics may be used for market analysis. In embodiments, by obtaining a person's facial expressions, the kind of advertisements a person is attracted to may be determined. For example, if a first company wants to target young adult females all around the world, before spending resources including money for providing advertisements on billboards, radio, tv, and other advertising mediums, the company may be able to conduct an efficient market analysis using the exemplary embodiments described herein. The company may run two trial advertisements, e.g., a green one and a blue one. If female young adults reacted (smiled, laughed, stared) at the green advertisement more than the blue advertisement, then the company may determine that green ads are more effective to target female young adults and may use this information for their advertisement campagin strategies.

In additional embodiments, analytics may be used to determine brand preferences for individuals in a particular geographic location. For example, individuals in a particular region may prefer a first brand over another. Additionally, analytics may be able to conduct an age analysis of individuals in a geographical location. For example, statistics regarding age demographics of individuals frequenting the defined space may be calculated. Alternatively, analytics may be applied to determine brand preferences related to age demographics. Analytics also, may be applied to determine any linkages or behavior patterns associated with external factors (such as weather) and brands or objects. For example, on hot days, individuals may prefer ice-cream of a particular brand, while on cold days, individuals may prefer coffee and/or certain brands associated with warm foods and beverages.

In an embodiment, processor 110 may be configured to receive and store instructions and data within databases 108 that is received from various sources including user or client devices 102 and information distribution system 104. Processor 110 or any additional processors within server system 106 also may be configured to provide content to information distribution system 104 for display. For example, processor 110 may transmit advertisement content to the information distribution system 104 for displaying. Processor 110 may also receive information and data captured or generated by the information distribution system 104.

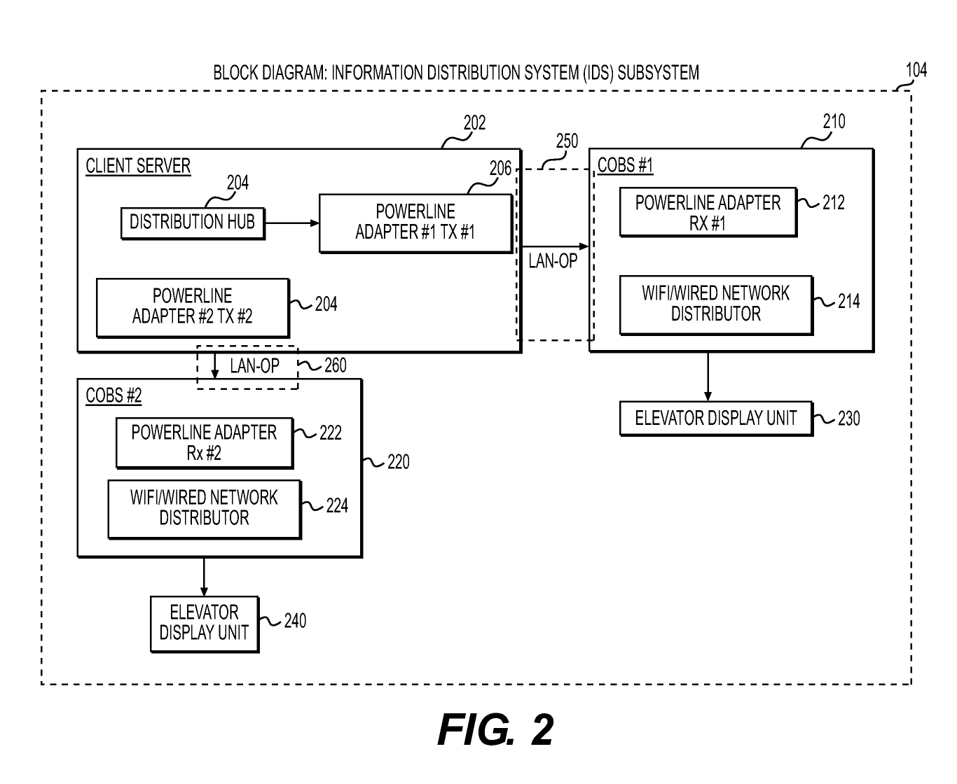

FIG. 2 is an illustration of an information distribution system 104, according to an embodiment of the present disclosure. Information distribution system 104 may include client server 202, elevator cab on-board servers (COB) 210 and 220, and elevator display units (EDU) 230 and 240. Within client server 202, distribution hub 204 may interface with electronic network 101 and also interface with Power Line Adapters Tx 206 and 208. Power Line Adapters Tx 206 and 208 may allow for communication with COBs 210 and 220 via Local Area Network over power lines (LAN-OP) 250 and 260. Distribution hub 204 may be connected to the internet through either a wired connection (such as, e.g., an RJ45 connector) or through Wi-Fi utilizing a network repeating function. In either case, distribution of the output signal may be through a wired connection (e.g., an RJ45 connection) to the next in-line system modulator. In some embodiments, distribution hub 204 may be, for example, a cellular router. Power Line Adapters Tx 206 and 208 may be broadband over power line modulating and demodulating adapters. For example, the adapters may be a D-Link™ DHP-500AV. Client server 202 may be powered by an uninterrupted electric circuit (for example, 110V-AC) that runs from an elevator power supply breaker located in an exemplary elevator control room to an elevator power supply located on, e.g., the roof of each elevator cab.

In some embodiments, the COBs 210 and 220 may comprise of Power line adapters Rx 212 and 222, respectively. Power line adapters Rx 212 and 222 may utilize the same power circuits utilized by Power line adapters Tx 206 and 208. Powerline adapters Rx 212 and 222 may be broadband over power line modulating and demodulating adapters. For example, the adapters may be a D-Link™ DHP-500AV. Accordingly, COBs 210 and 220 may receive or transmit data to client server 202 using powerline communication and the use of powerline adapters which are able to modulate and demodulate. Accordingly, client server 202 that is physically located inside a building elevator control room and COBS 230 and 240 that may be located on exterior roof of an elevator cab or the elevator shaft may communicate with each other using Power Line Adapters Tx 206 and 208 along with Power line adapters Rx 212 and 222.

In embodiments, each of COBs 210 and 220 may include WiFi/Wired Network Distributors 214 and 224. For example, Network Distributors 214 and 224 may transmit and/or receive data from EDUs 230 and 240. For example, Network Distributors 214 and 224 may be simple Wi-Fi (or wired) routers which transmit and receive data in an elevator shaft to the EDUs 230 and 214 that are located within an elevator cab.

In embodiments, EDUs 230 and 240 may be tablets (for example, but not limited to, Apple iPads™, Samsung Galaxy™ tablets, Windows Surface™ tablets, Windows™ All in-One PC), or a CPU with a display and a camera (or additional other suitable sensors) for capturing data. Furthermore, EDUs 230 and 240 may be any computing device which is able to display data in an elevator cab and/or acquire data related to individuals in the elevator cab.

In embodiments, EDUs 230 may contain functionality to wirelessly communicate with respective COBs 210 and 220. However, in embodiments, COBs 210 and 220 may communicate with EDUs 230 and 240 using power line or other wired connections. Accordingly, an administrator may be able to communicate with the tablets remotely using existing elevator electrical wiring which provides access to high speed internet. Embodiments of the present disclosure also may aid in reducing installation costs compared to conventional methods. For example, a tablet may be introduced into the elevator cab in a simple plug and play fashion. Further, as the electrical wiring of the elevator may be used to transmit an internet signal, additional installation of wiring and components may not be required. This may be accomplished by adding wireless connectively to the COBS, to facilitate communication with one or more tablets within one or more elevator cabs.

In embodiments, EDUs 230 and 240 may be located within the interior of an elevator cab. In some instances, EDUs 230 and 240 may include a PLS/IPS TFT Display, a Central Processing Unit (CPU), a stainless steel enclosure, among other features described in this disclosure. The CPU may be integrated within the EDUs to provide a multitude of different functions including, but not limited to, remote virtual networking, facial analytics, audio playback, social networking, and providing a touchscreen interface. Remote virtual networking may allow for seamless maintenance and the ability for offsite monitoring without the need for physical presence at the defined space. However, EDUs may contain a capacitive/multi-touch adapter that may allow for a person to provide inputs into an EDU for conducting in-person corrective or preventative maintenance on a device

In embodiments, EDUs 230 and 240 may be configured to conduct facial analytics. That is, EDUs 230 and 240 may be able to use image data (including e.g., a picture, thermal imaging, a live video feed, etc.) captured by a camera to determine one or more of an identity of a person, demographics of a person (such as gender, age, and ethnicity), mood of a person, etc.

In embodiments, EDUs 230 and 240 may also contain motion control technology such a motion control adapter which allows for interactivity between any displayed advertisement and a person in the elevator cab. For example, a person may use hand gestures to receive additional information about displayed advertisement. Additionally EDUs 230 and 240 may be operatively coupled to a device with Near Field Communication (NFC) capability. Accordingly, EDUs 230 and 240 may be able to establish communication with any elevator passenger's tablet, personal phones, or similar devices.

In embodiments, EDUs 230 and 240 also may contain a Social Networking Adapter which enables use of multiple platforms of social media for advertising and communication purposes. In some embodiments, a media value can be calculated based on a frequency of instances, enabling the advertisers a way of reaching their customers immediately. EDUs 230 and 240 may be configured to automatically pick up a feed from any of the clients posting offers for a certain product or service via social media and update the audience allowing for robust internet traffic analysis.

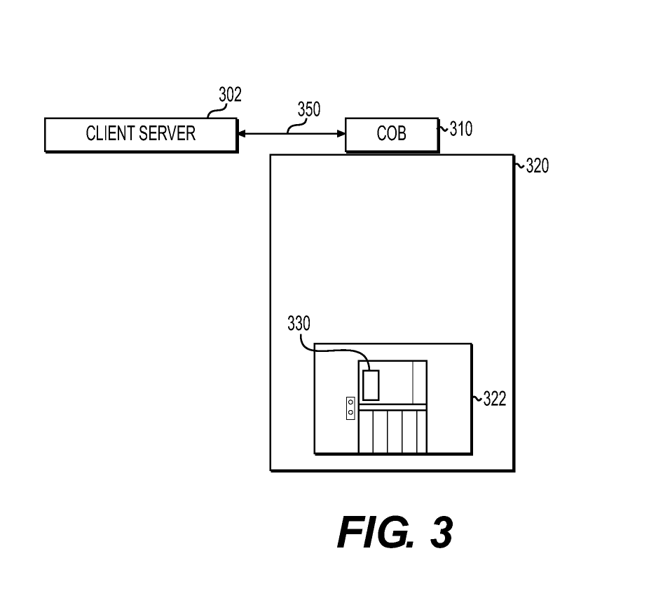

FIG. 3 is another block diagram of an information disclosing system 104, according to an embodiment of the present disclosure. In embodiments, client server 302, integrated LAN 350, COB 310, and EDU 330 may be similar to client server 202, Local Area Network over power lines (LAN-OP) 250, COB 210, and EDU 230 of FIG. 2. Client server 302 may be connected to COB 310 via integrated LAN 350. COB 310 may be placed on top of an elevator shaft 320. Elevator shaft 320 may contain an elevator cab 322 in which passengers may ride. Elevator cab 322 may include EDU 330. Accordingly, utilizing a Wi-Fi connection, COB 310 may transmit data to EDU 330 wirelessly. In other embodiments, COB 310 may be placed on the exterior of elevator cab 322 instead of elevator shaft 320. Analogously, COB 310 may be placed anywhere in the physical vicinity of a defined space where it may be able to wireless transmit a signal to an EDU.

In embodiments, EDU 310 may be configured to receive data from server system 106 directly instead of through client server 104. The data may be transmitted from server system 106 through various means including using LTE and similar connections.

FIG. 4 is a flow diagram of a method 400 for displaying advertising content in elevators, according to an embodiment of the present disclosure. In step 402, method 400 may include receiving data related to one or more individuals in an elevator. For example, this data may be received and/or retrieved by processor 110 from information distribution system 104. The data may include image data captured by a camera integrated with or coupled to EDU 230 or audio data captured by a microphone of EDU 230. Image data may include biometric data captured by the EDU 230 and data captured related to brands associated with individuals in an elevator cab. Additionally, the received data may be generated based on scanning of a cell phone or RFID associated with an individual, scanning of an access card used to gain access to an elevator, retina eye scanning, scanning of key cards, elevator keypads, etc. Additionally, any Bluetooth or Wi-Fi enabled device such as wearable heart-rate monitors and other portable medical devices may provide additional biometric data, or, in the case of mp3 players may provide an individual's music preferences, etc.

In embodiments, raw data may be received and stored in databases 108. Alternatively, EDU 230 may first process the raw data by performing facial detection or brand recognition and may then transmit data reflecting the results of such evaluation to the one or more system servers 106.

In step 404, method 400 may include identifying the one or more individuals based on the received data. The identification may include utilizing the received data to determine an identity of a person based on image/biometric data, determining demographic information about a person, or determining that a unique identity is assigned to the person.

In some embodiments, profiles may be created for each individual in an elevator. This may be done by, anonymously identifying an individual who has been in one of the elevators and then creating a profile of that individual and the individual's behavior based on data associated with the individual. The profile may be similar to user profiles that are crated based on individual's web browsing behavior which are often utilized for providing targeted or intelligent advertising content based on an individual's past behavior.

In embodiments, an individual may be identified anonymously utilizing various mechanisms. In one method, a unique identifier associated with a device carried by an individual may be utilized to identify that individual. For example, smartphones constantly send out short “pings” as they search for Wi-Fi networks nearby.

These pings include the phone's MAC address which is a unique identifier associated with the specific device which may be utilized as an identifier for the individual. In another method, while the collection of Wi-Fi networks that an individual's smartphone searches for may not be guaranteed to be unique but may be utilized as a reasonable proxy for assigning a unique identity. The Wi-Fi networks searching information along with an individual's gender and age may be utilized to assign a unique identity to an individual while at the same time retaining their anonymity. As an example, the Smiths (John, his wife, and their 18 year old daughter) live on the fifteenth floor of Building ABC. Their home Wi-Fi network is “Smithshome” and their phones, tablets and other devices are programmed to have the “Smithshome” network saved on the devices, so that their devices are always searching for this network or have it as a saved network on their devices. When any of the Smith's enter network environment 100, through their device's pings, the system may determine that a person whose device may be “pinging” is associated with the Smithshome network, and may also determine through facial detection if the individual is John, his wife, or the daughter. For example, the Smiths may be classified as male, adult-female, and teenager-female, respectively. Accordingly, this may be one efficient manner to identify an individual and create a profile related to them. In embodiments, the combination of networks that are being scanned by a device may serve as a very good proxy for a unique identifier—Mr. Smith will likely have his home network plus networks for his work, favorite lunch spots, gym etc., and no other individual, in his family or anywhere would likely have the same combination of networks. Accordingly, in combination with an individual's age and gender, this information may very accurately identify an individual.

In additional embodiments, captured data related to a user by EDU 230 may be utilized to determine an identity of the user. For example, data captured by an image from EDU 230 may be compared for facial recognition with publicly available data. For example, public sources of data such as an online social media platform in which users' provide their images may be used to identify occupants.

In some embodiments, user devices may be encoded with software applications that communicate their unique identity to the EDU 230. For example, tenants of a building may be able download blue-tooth enabled smartphone applications on to their phones. The smartphone application may allow for communications of smartphones with EDUs 210 and 220 via Bluetooth low-energy (BLE). The communication may allow for recognition of a particular individual associated with the smartphone application.

In some embodiments, method 400 may include step 406 which includes determining one or more brands associated with the one or more individuals based on the received data. Specially, data captured by a camera of EDU 230 may be utilized determine a brand preference of any individuals in the elevator. For example, captured image data may be used to determine if an individual is wearing clothes of a particular brand or is carrying accessories of a certain brand. Brand recognition may occur based on logo detection, determining unique brand patterns, or determining brand designs. Therefore, any brands displayed on clothing or accessories of an individual may be determined to be associated with the individual. For example, a shirt may be detected to be of a first brand and a handbag carried by an individual may be of a second brand. In such a scenario, the first and second brands may be associated with the individual.

In embodiments, additional brands may be associated with individuals based on learning algorithms or pre-set rules. For example, if a user is associated to two brands from a high-end category, it may be expected that they would be also interested in similar types of brands. Accordingly, additional brands from the high-end category may be associated with the user. This may aid in building a socio-demographic profile of an individual present in an elevator cab.

In embodiments, when a previous profile exists for a user, there stored brand preferences along with any new data revealing brand preference may be utilized to determine the one or more brands associated with the individual

In step 408, method 400 may include determining electronic content to display based on the identity of the one or more individuals and the associated brand. Rules may be pre-set for providing advertising content based on a user's identity (such as demographic information) and brand association. Utilizing such rules for efficient delivery of ads to which an individual might be more responsive.

As an example use case of method 400, a camera of EDU 230 may capture image data of a first person in an elevator. The captured image data may be utilized to determine that the person in the elevator is John Smith and is wearing a first brand of clothes. Databases 108 may include information related to the demographics of John Smith and other brands associated with the first brand of clothes. Accordingly, using the demographic information and the other brands, targeted advertising form a library of potential advertising content may be immediately provided to John Smith on a display of EDU 230.

In embodiments, determining electronic content to display may further be based on an individual's previous reactions such as prior reaction to various products, services and brands. These reactions may have been determined using facial analysis, which is described in further detail below.

Additionally, the particular electronic content to be displayed may be based other external information such as time of day, date, current weather, and location of the elevator. Additionally, the particular electronic content may be chosen based on a frequency of display specified by an advertising entity, specific advertising time blocks, and rotations for specific advertising content. An administrator may be able to set rules on what information to provide for display based on the external information. For example, when temperatures are below forty degrees Fahrenheit, vacations to tropical destinations may be displayed. Alternatively, certain advertisement contents may be displayed only at night.

In embodiments, facial detection techniques may be applied on data captured by a camera in EDU 230 to determine conversion rates and or potential customer reaction. For example, data may be captured to identify the individuals who looked at a given ad. Additionally, facial expressions may be determined based on captured data indicating an individual's reaction to an advertisement. For example, not only did an individual look at an advertisement but also appeared to be excited about the content displayed.

In additional embodiments, data related to conversion rates of advertisements or reactions may be utilized for analytics related to advertising content. For example, reaction related data may be categorized based on user's genders, age groups, weights, and other categories. Such categorization allows advertisers to measure the effectiveness of their advertising campaigns with respect to particular groups. This may allow future advertising to be more accurate and further targeted based on probabilities associated with reactions of individuals in a particular group.

In some embodiments, an individual in an elevator cab may be able to interact with the displayed information on EDU 230. For example, once advertising content is displayed, Motion Control Adapters may be utilized to interpret hand gestures by occupants of the elevator cab. For example, hand gestures may be used to spin a virtual wheel to see what kind of discount coupon they might receive. The result of the action by the occupant may require additional interactivity (e.g. tapping the NFC) in order to deliver a customized offer for the individual. In embodiments, Near Field Communication (NFC) may allow occupants to tap their smartphones on a screen of EDUs 230 and 240 to receive more information about a product, service, brand, special discount offers, or to enroll in a contest, etc. When a phone is tapped, it may be determined which advertisement is being displayed when the phone is tapped on the screen and a URL associated with the NFC chip may dynamically redirect to an associated appropriate web page which may be displayed on the smartphone.

In additional embodiments, smartphone cameras may be used to scan QR codes displayed on a screen of EDUs 230 and 240 to receive information similarly to tapping mechanism of NFC. Additionally, these smart phones may text numbers displayed on the screen to automatically receive additional information regarding advertising content. Furthermore, smartphones belonging to individuals may utilize information from EDUs 230 and 240 to interact with variety of social networking platforms.

In embodiments, live feeds or other content may be incorporated into information or content that is provided to an audience in a defined space. The content may be displayed on a display screen in the defined space or an audio may be transmitted through speakers, in addition to other means of relaying information. The content may include social media live feed (such as a live Twitter™ feed, internet radio or additional audio (including music or advertisements), game show interactivity (where a person may be a contestant on a game show), and information related to lotteries. For example, information may be displayed regarding how many tickets have been bought for a certain pot (for lottery), the odds of winning, and total jackpot. Additionally, based on displayed advertisement, a person may be able to purchase tickets (lottery or to events) using NFC, QR Code, or SMS, etc. For example, in some countries, SMS is used extensively for purchasing items and conducting additional transactions. In one example, contests run by advertisers may be facilitated. Specifically, a user may tap NFC to enter the contest, scan a QR code, or send an SMS to a specific number (for example, text #WIN to 03660). In another embodiment, in a contest, an nth customer to tap NFC, scan a QR code, or SMS a particular number may win the contest, such as winning a trip for two, similar to radio station giveaways.

In embodiments, an individual may SMS a number displayed on an elevator display to enter or win contests, to get picked up by a taxi service, or to order products (including good and clothes). Based on a location associated with an individual, a taxi service or the ordered materials may be sent to a pre-determined location. Alternatively, the individual may be able to specify preferred locations.

In embodiments, various entities may utilized data analytics' related to individuals in elevator cabs to provide efficient and target advertising. Additionally, these entities including individuals, small business owners, corporations, marketers or media buyers may utilizes interfaces, such as a map view, to select the properties whose elevators they wish to advertise in.

In some embodiments, when there are multiple individuals present in an elevator, the advertising content to display may be selected based on various rules. The rules may include providing content relevant to most passengers, providing content that is likely to lead to the highest conversion rates, providing content that is directed to the most expensive products, etc. For example, there are three passengers in an elevator, where based on their previously generated user profiles, two of them have a preference for a first product and the third person has a preference for a second product. If the rules state that advertising content is provided that is more relevant to the most passengers, advertising content related to the first product would be displayed.

In embodiments, audio captured from a microphone coupled to EDUs 230 and 240 may be used for voice recognition or for determining a topic of discussion. Regarding voice recognition, captured data may be used to determine an identity of the person speaking in the elevator. Utilizing a previously generated profile of the person who is speaking, targeted advertising based on an individual's preferences may be provided. Regarding determining a topic of discussion, word or context recognition may be used to determine what the topic of discussion or if a particular word is stated. For example, if data related to a person's audio reveals that they are hungry, then advertising content related to eating establishments (for example, a restaurant located within the building having the elevator containing the display) may be displayed or provided through speakers coupled to EDUs 230 and 240. Alternatively, it may be determined that an individual verbally stated the name of a particular product, such us a brand or type of a drink, and related advertising content may be provided.

In other embodiments, a combination of voice recognition and determination of a topic of discussion may be utilized. For example, from voice recognition, an individual's previously generated profile may be retrieved including their brand preferences or spending habits, etc. This information may be used along with the topic of discussion to provide targeted advertising content. For example, previous brand recognition instances may indicate that a person has worn shirts of a particular brand. Accordingly, if it is captured that an individual is planning on going on a vacation (for example, based on captured audio), clothing advertisement from that brand relevant to the temperature of the destination may be provided. For example, a person travelling to Hawaii may be provided advertisement of swimming suits and shorts, or advertising content related to the destination.

In embodiments, data captured from EDUs 230 and 240 may be used for a rewards program. For example, an eatery in the vicinity of a building may have a rewards program that may use data captured in an elevator. For example, a point may be awarded to a person each time captured image data indicates that the person is carrying a bag from that eatery. After a certain amount of points, a coupon may be provided offering a free sandwich, drink, etc. The coupon may be provided via a display of the EDUs 230 and 240, may be automatically transmitted to a device carried by the person from EDUs 230 and 240, emailed to an email address associated with the person, or through any other mechanism for providing data.

The examples described above with respect to FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

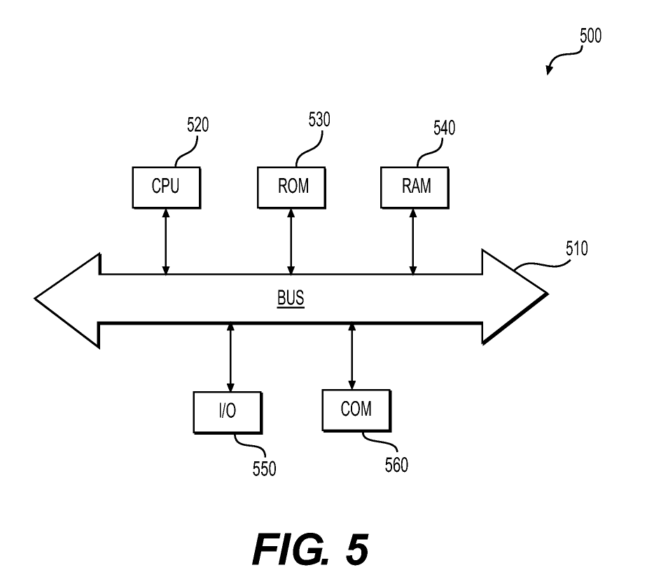

FIG. 5 illustrates a high-level functional block diagram of an exemplary computer system 500, in which embodiments of the present disclosure, or portions thereof, may be implemented, e.g., as computer-readable code. For example, each of the exemplary devices and systems described above with respect to FIG. 1 can be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIG. 1, as described above.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 1-4, may be implemented using computer system 500. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 5, computer system 500 includes a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example, a bus, message queue, network, or multi-core message-passing scheme.

Computer system 500 also may include a main memory 540, for example, random access memory (RAM), and also may include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc. which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into computer system 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to computer system 500.

Computer system 500 also may include a communications interface (“COM”) 560. Communications interface 560 allows software and data to be transferred between computer system 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of computer system 500, which may be implemented using, for example, wire or cable, fiber optics, a phone line, a cellular phone link, an RF link or other communications channels.

The hardware elements, operating systems, and programming languages of such equipment are conventional in nature, and it is presumed that those skilled in the art are adequately familiar therewith. Computer system 500 also may include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for providing information in a defined space, the method comprising:
receiving, by at least one processor, data related to one or more individuals in the defined space;
identifying, using the at least one processor, the one or more individuals based on the received data;
identifying, using the at least one processor, one or more brands associated with the one or more individuals based on the received data; and
determining, using the at least one processor, the information to provide based on the identification of the one or more individuals and the identification of the one or more brands associated with the one or more individuals.

2. The computer-implemented method of claim 1, wherein providing information includes graphically displaying images on a screen.

3. The computer-implemented method of claim 2, further comprising:
interacting with the graphically displayed images on the screen.

4. The computer-implemented method of claim 3, wherein the interacting comprises using one or more of social media platforms, motions, voice, texting, touching, NFC, and Bluetooth.

5. The computer-implemented method of claim 1, wherein receiving the data related to one or more individuals in the defined space comprises receiving data related to the one or more individual that is captured by one or more sensors in the defined space.

6. The computer-implemented method of claim 5, wherein the one or more sensors include a camera, a microphone, and a motion detector.

7. The computer-implemented method of claim 6, wherein identifying the one or more individuals based on the received data comprises identifying the one or more individuals by determining one or more of biometric information, demographic information, facial expression, mac address, and WiFi networks saved in a device associated with a respective individual.

8. The computer-implemented method of claim 7, wherein identifying the one or more brands associated with the one or more individuals based on the received data comprises determining respective brands of products worn, carried by, or discussed by the one or more individuals using data captured by the one or more sensors.

9. The computer-implemented method of claim 5, wherein determining the information to provide further comprises:
determining the information to provide is based additionally on one or more of weather, time of day, and geographical location.

10. The computer-implemented method of claim 1, wherein the defined space is an elevator and the information is electronic advertisement.

11. The computer-implemented method of claim 10, wherein a display device in the elevator is connected to a client on-board server that is connected to a client server disposed in an elevator control room using an electrical power conduit.

12. The computer-implemented method of claim 10, wherein a display device in the elevator is connected to a server providing the information using an LTE connection.

13. The computer-implemented method of claim 1, further comprising:
providing the information to a display device in the defined space for displaying.

14. A system for providing information, the system comprising:
a memory having processor-readable instructions stored therein; and
a processor configured to access the memory and execute the processor-readable instructions, which when executed by the processor configures the processor to perform a method, the method comprising:
receiving data related to one or more individuals in the defined space;
identifying the one or more individuals based on the received data;
identifying one or more brands associated with the one or more individuals based on the received data; and
determining the information to provide based on the identification of the one or more individuals and the identification of the one or more brands associated with the one or more individuals.

15. The system of claim 14, wherein providing information include graphically displaying images on a screen.

16. The computer-implemented method of claim 15, wherein the method further comprises:
interacting with the graphically displayed images on the screen.

17. The system of claim 16, wherein the interacting comprises using one or more of social media platforms, motions, voice, texting, touching, NFC, and Bluetooth.

18. The system of claim 14, wherein receiving the data related to one or more individuals in the defined space comprises receiving data related to the one or more individuals that is captured by one or more sensors in the defined space.

19. The system of claim 18, wherein the one or more sensors include a camera, a microphone, and a motion detector.

20. The system of claim 19, wherein identifying the one or more individuals based on the received data comprises identifying the one or more individuals by determining one or more of biometric information, demographic information, facial expression, mac address, and Wi-Fi networks saved in a device associated with a respective individual.

21. The system of claim 20, wherein identifying the one or more brands associated with the one or more individuals based on the received data comprises determining respective brands of products worn, carried by, or discussed by the one or more individuals using data captured by the one or more sensors.

22. A non-transitory computer-readable medium storing instructions, then instructions, when executed by a computer system cause the computer system to perform a method, the method comprising:
receiving data related to one or more individuals in the defined space;
identifying the one or more individuals based on the received data;
identifying one or more brands associated with the one or more individuals based on the received data; and
determining the information to provide based on the identification of the one or more individuals and the identification of the one or more brands associated with the one or more individuals.

23. The non-transitory computer-readable medium of claim 22, wherein providing information include graphically displaying images on a screen.

24. The non-transitory computer-readable medium of claim 23, wherein the method further comprises:
interacting with the graphically displayed images on the screen.

25. The non-transitory computer-readable medium of claim 24, wherein the interacting comprises using one or more of social media platforms, motions, voice, texting, touching, NFC, and Bluetooth.

26. The non-transitory computer-readable medium of claim 22, wherein receiving the data related to one or more individuals in the defined space comprises receiving data related to the one or more individuals that is captured by one or more sensors in the defined space.

27. The non-transitory computer-readable medium of claim 26, wherein the one or more sensors include a camera, a microphone, and a motion detector.

28. The non-transitory computer-readable medium of claim 27, wherein identifying the one or more individuals based on the received data comprises identifying the one or more individuals by determining one or more of biometric information, demographic information, facial expression, mac address, and Wi-Fi networks saved in a device associated with a respective individual.

29. The non-transitory computer-readable medium of claim 28, wherein identifying the one or more brands associated with the one or more individuals based on the received data comprises determining respective brands of products worn, carried by, or discussed by the one or more individuals using data captured by the one or more sensors.
